(19) United States
(12) Patent Application Publication
(10) Pub. No.: US 2025/0225368 A1
(43) Pub. Date: Jul. 10, 2025

(54) PROCESS CONTROL BASED ON SIMULTANEOUS MACHINE LEARNING OF SPATIAL AND TEMPORAL RELATIONS OF TIME SERIES DATA

(71) Applicant: International Business Machines Corporation, Armonk, NY (US)

(72) Inventors: Lam Minh Nguyen, Ossining, NY (US); Huyen Trang Tran, Ithaca, NY (US)

(21) Appl. No.: 18/405,462

(22) Filed: Jan. 5, 2024

(51) Int. Cl. G06N 3/045; G06N 3/08

(52) U.S. Cl. CPC G06N 3/045; G06N 3/08

(57) ABSTRACT

According to an embodiment of the present invention, one or more sets of time series data values recorded from operation of a system for respective features of the system are received. A first machine learning model imputes missing data values from the one or more sets of time series data values. A second machine learning model predicts data values for the features for a future time based on receiving the set of time series data values and the imputed data values from the first machine learning model as input. The first and the second machine learning models implement different functions for corresponding different features of the system. One or more commands are generated for control operations for the system based on the predicted data values.

### BACKGROUND

### 1. Technical Field

Present invention embodiments relate to process control, and more specifically, to process control employing one or more machine learning (ML) models that simultaneously learn spatial and temporal relations of time series data for predicting future data values.

### SUMMARY

According to one embodiment of the present invention, one or more sets of time series data values recorded from operation of a system for respective features of the system are received. A first machine learning model imputes missing data values from the one or more sets of time series data values. A second machine learning model predicts data values for the features for a future time based on receiving the set of time series data values and the imputed data values from the first machine learning model as input. The first and the second machine learning models implement different functions for corresponding different features of the system. One or more commands are generated for control operations for the system based on the predicted data values.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a flow diagram of a manner of predicting or forecasting time series data according to an embodiment of the present invention.

FIG. 3 is a flow diagram of a time series machine learning model according to an embodiment of the present invention.

FIG. 4 is a flow diagram of a manner of learning spatial and temporal relations of time series data according to an embodiment of the present invention.

FIGS. 5A-FIG. 5B illustrate a spatial machine learning model to impute missing data according to an embodiment of the present invention.

FIGS. 6A-6B illustrate a temporal machine learning model to predict future data according to an embodiment of the present invention

FIG. 7 is a procedural flowchart of a manner of processing time series data according to an embodiment of the present invention.

FIG. 8 is a flow diagram of a machine control system according to an embodiment of the present invention.

FIG. 9 illustrates operational data results of an embodiment of the present invention relative to conventional approaches.

### DETAILED DESCRIPTION

Determining a multiple-step ahead prediction of a system state given a set of sensor observations is an interest in many industrial applications (e.g., chemical reactors, wind farm, power grid, blast furnace, etc.). While most time series models assume regularly sampled multivariate data, in most real-life applications, a time series data set contains a significant amount of missing entries. This is due to either database corruption, sensor failure, or a multi-resolution sensor network. However, most previous models are based on a single isolated task, either imputation or prediction.

Accordingly, an embodiment of the present invention provides a multi-task framework for time series processing. The framework learns imputation and forecasting tasks simultaneously, where a loss function is designed such that a time series machine learning (ML) model uses forecast predictions to improve imputation performance, and vice versa. The framework handles full data and missing data in its natural process. The time series ML model includes learning functions that learn spatial relations and temporal relations of a time series dynamic. These learning functions or machine learning models are trained simultaneously. The framework provides greater empirical performance relative to conventional techniques for both imputation and forecasting tasks.

An embodiment of the present invention provides a dynamic time series framework that learns imputation and forecasting tasks simultaneously. The framework includes learning functions to learn the spatial and temporal relations of time series data. A loss function allows forecasting signals to better predict missing values, and the imputation is adapted to be part of the input of the forecasting task and learns a spatial relation simultaneously. Architectures are provided for the learning functions, where each time index or feature index may have a separate function. The learned function may be designed as (A) a fully connected network (for a spatial relation) for a first function or machine learning model and/or (B) linear layers combined with depth-wise convolution (for a temporal relation) for a second function or machine learning model. An integrated loss function between the two sub-models or sub-functions allows the spatial and temporal relations to interact with each other. The time series signals are involved simultaneously in both tasks. The special architecture allows the model to capture separate spatial dynamic for each feature, while maintaining the same temporal dynamic for the time series sequence.

An embodiment of the present invention employs a time series machine learning (ML) model that simultaneously imputes missing entries and determines a multiple-step ahead prediction. The prediction includes one or both of a single-step ahead prediction and multiple-step ahead predictions. The multiple-step ahead predictions refer to predictions using a selected standard time unit (e.g., minutes, hours, days, etc.) and generating predictions for minutes, hours, days, etc. that are multiple values ahead of the current unit. The time series ML model simultaneously learns spatial and temporal relations between features (corresponding to time series data elements) for various scenarios providing time series data (e.g., machine/system process controls, etc.). The time series ML model includes learning functions for learning spatial and temporal relations between features. The time series ML model includes learnable relations among features through data and time. Moreover, these learnable relations are dependent on each other. A spatial learning relation or function, f, is presumably invariant in the time dimension and captures the spatial relation of time series data. The time series ML model can be employed for different time series tasks, such as forecasting, imputation, regression, and classification.

An embodiment of the present invention employs a time series machine learning (ML) model that learns the dynamic between time steps and features. A flexible framework accommodates different time series tasks, such as forecasting, imputation, regression, and classification. The time series ML model may learn directly from missing data, or learn a full representation of the data and infer knowledge adaptively.

An embodiment of the present invention provides a framework that trains imputation and forecasting tasks simultaneously. The representation of full data is flexible and learnable. Conventional approaches flatten matrices for temporal and spatial dimensions, or allow cross-connections between indexes of different time steps and features. However, at least some of the present invention embodiments use separable functions for an architecture of learning functions, but train them jointly for a time series machine learning (ML) model to learn the cross-connections in a consecutive way. Temporal and spatial relations are learned simultaneously, and imputation is integrated into a process of learning a spatial function in order to perform imputation and forecasting simultaneously. The spatial learning function may be trained as a fully connected (neural) network, while the temporal learning function may be trained as linear (neural network) layers combined with a depth-wise convolution with a separate function for each feature. Further, the depth-wise convolution allows the time series ML model to separate feature channels and enables lightweight models.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

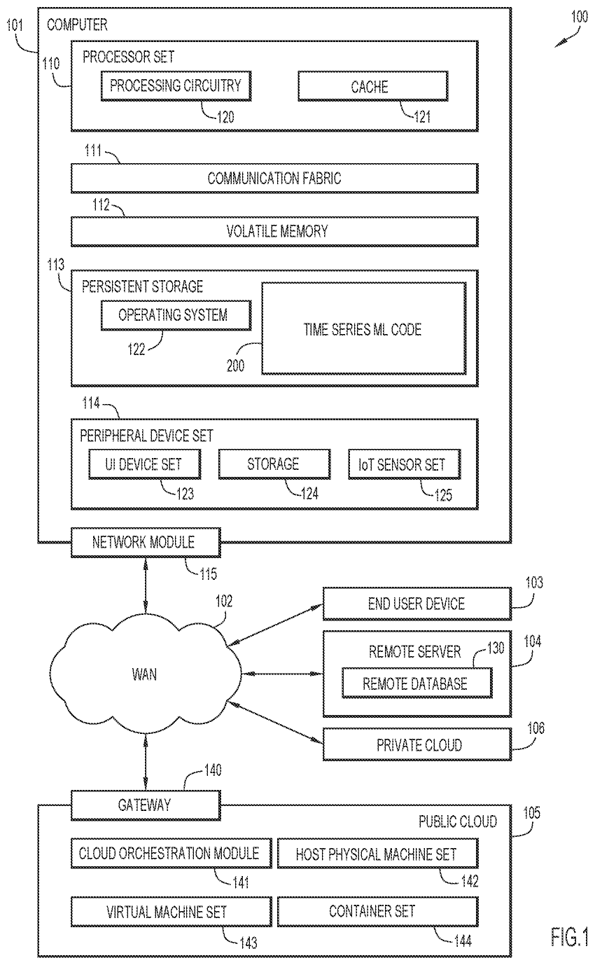

Referring to FIG. 1, computing environment 100 contains an example of an environment for the execution of at least some of the computer code involved in performing the inventive methods, such as time series machine learning (ML) code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computer 101 in some embodiments also hosts one or more machine learning models such as the time series ML model and/or individual ML models or functions that are part of the overall time series ML model. A machine learning model in one embodiment is stored in the persistent storage 113 of the computer 101. Received time series data are input to the machine learning model via an intra-computer transmission within the computer 101, e.g., via the communication fabric 111, to a different memory region hosting the machine learning model.

In some embodiments, one or more machine learning models are stored in computer memory of a computer positioned remotely from the computer 101, e.g., in a remote server 104 or in an end user device 103. In this embodiment, the code 200 works remotely with this machine learning model to train same and to utilize same. Training instructions are sent via a transmission that starts from the computer 101, passes through the WAN 102, and ends at the destination computer that hosts the machine learning model. Thus, in some embodiments the code 200 at the computer 101 or another instance of the software at a central remote server performs routing of training instructions to multiple server/geographical locations in a distributed system.

In such embodiments, a remote machine learning model is configured to send its output back to the computer 101 so that inference and time series predictions produced by the trained model or by functions thereof are provided and presented to a user. The machine learning model receives a copy of a new data sample, performs machine learning analysis on the received sample, and transmits the results, e.g., an output such as a prediction of future time series data and/or a command for process control action back to the computer 101 for presentation there e.g., via a display screen of the UI device set 123, and/or for execution there.

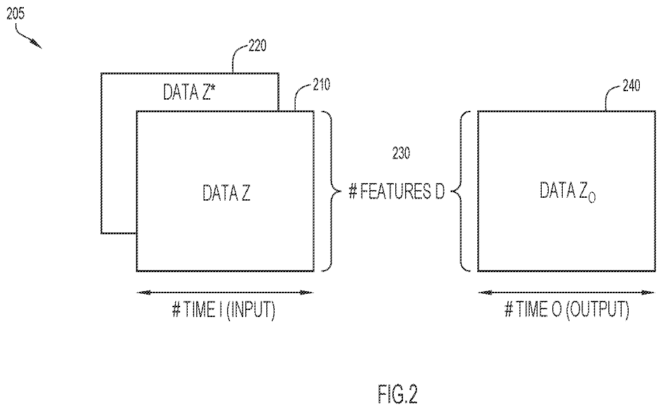

A method 205 of predicting or forecasting time series data according to an embodiment of the present invention is illustrated in FIG. 2. Initially, ground truth time series data set 210 may be represented by Z∈R^{I×d}, where R is a two dimensional set (or matrix) of real numbers or values, I is an input time dimension and d (or D in FIG. 2) is a number of features 230. The features may correspond to data obtained at time intervals or time steps in the time dimension, and may provide information about a state of a system. The features may indicate any attributes, characteristics, and/or properties of a system, component, and/or other item (e.g., temperature, power, pressure, etc.). For example, in operation of a chemical system, the features may include temperature, pressure, concentration of chemicals, quality of material, throughput, etc. The features may be obtained based on sensors (e.g., temperature, pressure, concentration, etc.), and/or may be derived from other or measured features.

The forecast task is to predict future values for future time series data set 240, Z_{O}∈R^{O×d}, where R is a two dimensional set (or matrix) of real numbers, O is an output time dimension and d is the number of features (preferably the same number and features as the input time dimension). By way of example, the forecast task may predict data for a future time (e.g., the next day, week, month, etc.) based on data of current and/or previous times (e.g., the current and prior day, week, month, etc.). Time series data set 210 (Data Z) and future data set 240 (Data Z_{O}) may be represented by matrices having the time dimension as rows and features as columns.

Time series data set 220 includes time series data set 210 with missing entries and may be represented by Z*∈R^{I×d}, where R is a two dimensional set (or matrix) of real numbers, I is the input time dimension, and d is the number of features as described above for time series data set 210. Masks may be used to identify missing data in a time series data set (e.g., a one (1) may indicate presence of data and a zero (0) may indicate missing data, etc.). However, time series data sets 210, 220, and 240 may include any types of numbers or values (e.g., real, integer, etc.), and the time dimensions may include any time interval or time steps (e.g., seconds, minutes, hours, days, portions thereof, etc.). Time series data sets 210, 220, 240 may include any data arranged or associated with time. A present invention embodiment deals with the missing entries and infers knowledge (or future values) based on partially observed data.

A conventional approach is to employ an imputation model to construct a full data set from a partial data set (e.g., a data set with missing entries). The constructed full data set is applied to an inference model to predict future data or infer knowledge. However, the inference model has no access to the original data (e.g. partial data set) and the constructed full data set is fixed and not learnable.

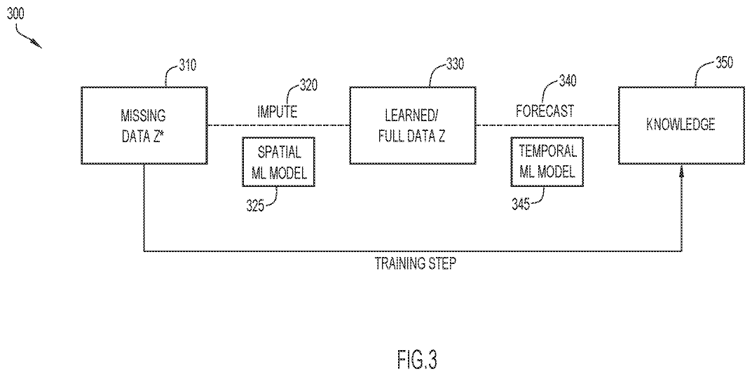

Accordingly, an embodiment of the present invention provides a time series machine learning (ML) model 300 for imputation and forecasting as illustrated in FIG. 3. Initially, a partial time series data set 310 is substantially similar to data set 220 described above and includes missing data relative to a full data set. Partial time series data set 310 (e.g., Data Z* as viewed in FIG. 3) may be expressed as Z*∈R^{I×d}. Partial time series data set 310 may be represented by a matrix having the time dimension (I) as rows and features (d) as columns as described above. A mask may be used (or applied) to identify missing data in the time series data (e.g., a one (1) may indicate presence of data and a zero (0) may indicate missing data, etc.). Time series machine learning (ML) model 300 may include a spatial machine learning (ML) model 325 to impute (or infer or determine) missing data and a temporal machine learning (ML) model 345 to predict future data. The imputed data for some features may be derived from other features. The time series machine learning (ML) model imputes the missing data (via spatial machine learning (ML) model 325) at operation 320 to produce a learned full data set 330 (e.g., Data Z as viewed in FIG. 3). The learned full data set is used to forecast or predict future data or infer knowledge 350 (via temporal machine learning model 345) at operation 340. The time series machine learning model trains spatial and temporal machine learning models for imputation and forecasting simultaneously, and may utilize signals from forecasting tasks to improve imputation. The overall quality of forecasting via use of the so-trained time series machine learning model achieves improvement.

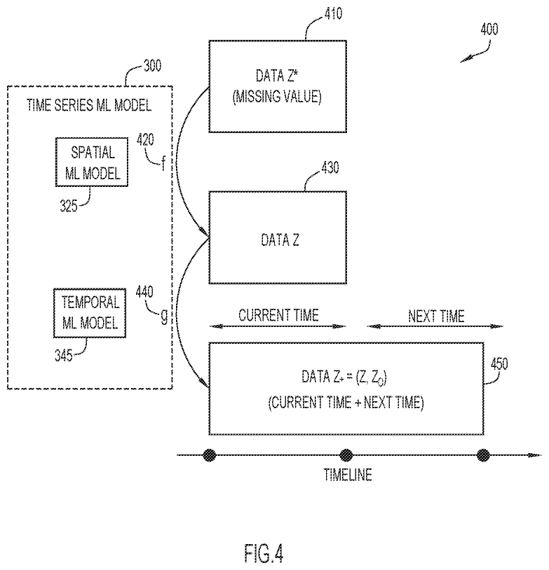

A method 400 of learning spatial and temporal relations of time series data according to an embodiment of the present invention is illustrated in FIG. 4. Initially, a partial time series data set 410 (e.g., Data Z* as viewed in FIG. 4) relative to a full time series data set is substantially similar to time series data sets 220, 310 described above and includes the full time series data set with missing values. The missing values may be indicated within partial data set 410 by a mask (e.g., a one (1) may indicate presence of data and a zero (0) may indicate missing data, etc.) in substantially the same manner described above. A relation or mapping of the full data set to partial data set 410 (Data Z*) may be expressed as Z=f(Z*). In other words, a function 420 (e.g., function f as viewed in FIG. 4) is a dynamic that produces a full data set 430 (e.g., Data Z as viewed in FIG. 4) from partial data set 410 (Data Z*), and represents an imputation operation. Function 420 is invariant in the time dimension, captures the spatial relation of time series data, and may be learned (e.g., by spatial ML model 325). Full data set 430 may be substantially similar to data sets 210, 330 described above.

A predicted time series data set 450 (e.g., Data Z+ as viewed in FIG. 4) includes information of current and future times. For example, predicted data set 450 may include full data set 430 (Data Z) and a future data set with predicted future values (e.g., Data Z_{O} as viewed in FIG. 4) that is substantially similar to future data set 240 described above. In some embodiments, the predicted time series data set 450 includes information of future times and not information from current times. In at least some embodiments, partial data set 410 (Data Z*), full data set 430 (Data Z), and predicted data set 450 (Data Z+) are represented by matrices having a time dimension as rows and features as columns in substantially the same manner described above. Masks may be used to identify missing data in a time series data set (e.g., a one (1) may indicate presence of data and a zero (0) may indicate missing data, etc.). A relation or mapping of imputed full data set 430 (Data Z) to predicted data set 450 with future values (Data Z+) for features may be expressed as Z+=g (Z). In other words, g (Z) represents a set of functions 440 that produces predicted data set 450 (Data Z+) for features from the imputed data set 430 (Data Z), and represents forecasting, prediction, and/or inference operations. Set of functions 440 may include a function (e.g., g₁, g₂, . . . g_{d}) for each of d features in full data set 430, and may be learned (e.g., by temporal ML model 345).

Machine learning (ML) may be employed (e.g., spatial ML model 325 and temporal ML model 345) to learn dynamics or functions 420, 440 (functions f and g) (e.g., Z=f(Z*) and Z+=g(Z)). Time series machine learning model 300 may include any quantity of any conventional or other machine learning models to implement functions 420, 440 (e.g., mathematical/statistical models, classifiers, feed-forward (fully or partially connected), recurrent (RNN), convolutional (CNN), or other neural networks, deep learning models, long short-term memory (LSTM), attention-based methods/transformers, etc.).

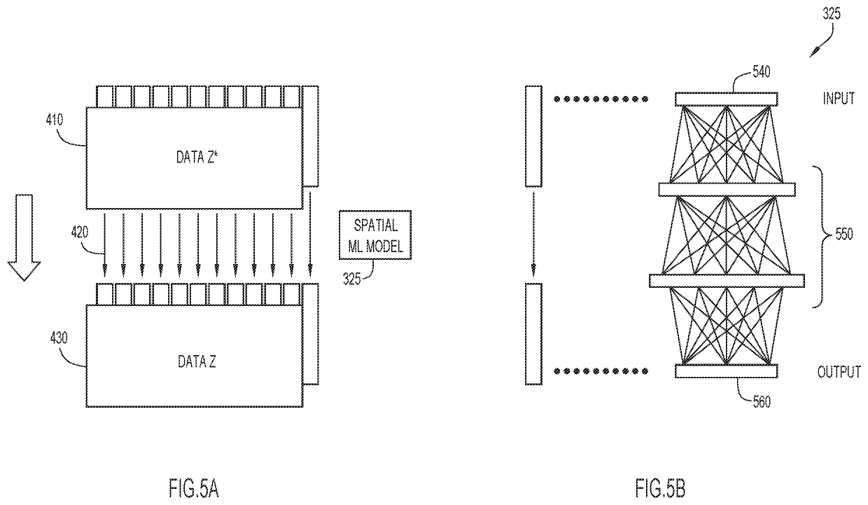

Spatial machine learning (ML) model 325 of time series machine learning (ML) model 300 to impute missing data according to an embodiment of the present invention is illustrated in FIGS. 5A-5B. Initially, partial time series data set 410 (e.g., Data Z* as viewed in FIG. 5A) includes missing data relative to a full data set as described above. Partial data set 410 may be represented by a matrix having a time dimension as rows and features as columns as described above. A mask may be used (or applied), e.g., within the matrix, to identify missing data in the time series data set (e.g., a one (1) may indicate presence of data and a zero (0) may indicate missing data, etc.). Spatial machine learning model 325 processes the partial data set to impute the missing values (based on function 420 (or function f)) and produce full data set 430 (e.g., Data Z as viewed in FIG. 5A). Spatial machine learning model 325 may be implemented by any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, etc.).

By way of example, spatial machine learning model 325 includes in some embodiments a fully connected (e.g., feed forward, etc.) neural network (FIG. 5B). The neural network may include an input layer 540, one or more intermediate layers (e.g., including any hidden layers) 550, and an output layer 560. Each layer includes one or more neurons, where the input layer neurons receive input (e.g., actual data, feature vectors derived from the actual data, etc.), and may be associated with weight values. The neurons of the intermediate layers 550 and output layers 560 are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques (e.g., backpropagation, etc.). For example, the machine learning model may be trained with a training set of partial data or features derived from the partial data, where the neural network attempts to produce the provided or known data (e.g., full data set) and uses an error from the output (e.g., difference between inputs and outputs) (and the prediction error from temporal machine learning model 345) to adjust weight (and bias) values. The output layer of the neural network indicates a corresponding full data set for input data. The full data set of the training data is used for supervised learning in which the correct answers from the full training data set are used to guide ML model adjustment, e.g., weight and/or bias adjustment, to cause the ML model to correctly predict missing values that were missing from the partial training data input into the ML model. Thus, the training data is broken down into a full training data set and a partial dataset which are used in conjunction for supervised learning.

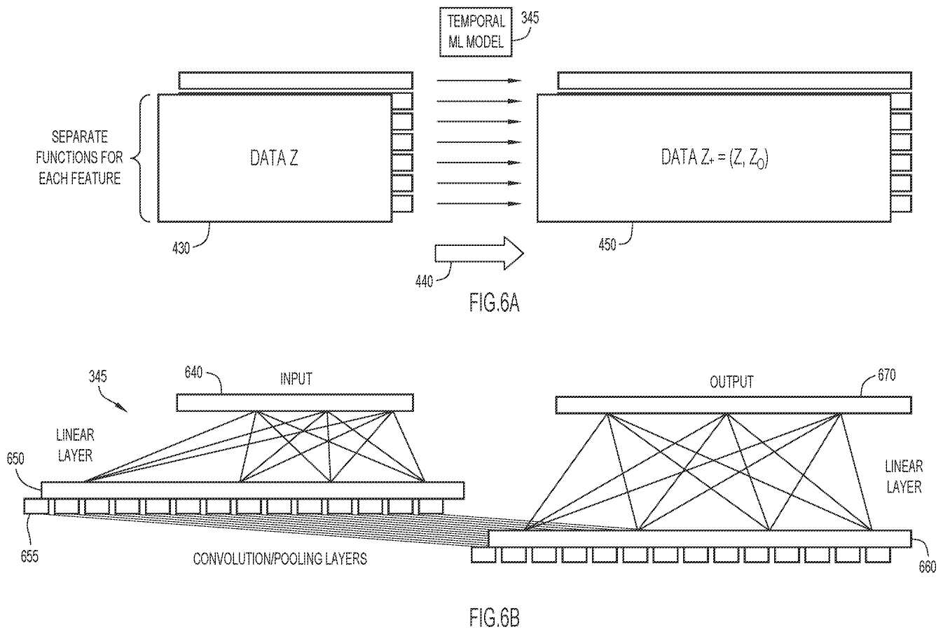

Temporal machine learning (ML) model 345 of time series machine learning (ML) model 300 to predict future data according to an embodiment of the present invention is illustrated in FIGS. 6A-6B. Initially, data set 430 (e.g., Data Z as viewed in FIG. 6A) includes a full data set produced from function 420 (or spatial machine learning model 325) as described above. The full data set 430 includes a number of features d for each time interval or step. The full data set 430 (Data Z) is time series data and is represented in some embodiments by a matrix having a time dimension as rows and features as columns as described above. Temporal machine learning model 345 processes the full data set to predict future data values (based on set of functions 440 (or function g)) and produce predicted time series data set 450 (e.g., Data Z+ as viewed in FIG. 6A) with current and future data values corresponding to the features as described above. Predicted data set 450 (Z+) in some embodiments is represented by a matrix having a time dimension as rows and features as columns as described above. A mask may be used (or applied), e.g., within the matrix, to identify missing data in a time series data set (e.g., a one (1) may indicate presence of data and a zero (0) may indicate missing data, etc.).

Temporal machine learning model 345 may process data for corresponding features to produce current and future values for those features. Temporal machine learning model 345 may be implemented by any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, etc.).

By way of example, temporal machine learning model 345 includes in some embodiments a convolutional neural network (CNN) (FIG. 6B). The convolutional neural network (CNN) may include an input (or linear) layer 640, one or more intermediate (or convolution and optional pooling) layers 650, 660 to perform depth-wise separable convolution for each feature (e.g., with one kernel 655 for each feature), and an output (or linear) layer 670. The lines between kernels 655 adjacent the intermediate layer 650 and the other kernels adjacent the intermediate layer 660 illustrate this aspect of one kernel per each feature. Each layer includes one or more neurons, where the input layer neurons receive input (e.g., actual data, feature vectors derived from the actual data, etc.), and may be associated with weight values. The neurons of the intermediate and output layers are connected to one or more neurons of a preceding layer (e.g., the input and output layers may be fully connected to an adjacent layer, while the convolution layers may be partially connected (or connected to specific areas/neurons)), and receive as input the output of a connected neuron of the preceding layer. The convolution layers include specific connections between neurons and extract or isolate the features within time series data to enable the individual features to be processed (e.g., a depth-wise separable convolution on the feature) to learn and implement a corresponding function g for the feature. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques (e.g., backpropagation, etc.). This architecture enables set of functions 440 (e.g., a function for each feature) to be trained simultaneously. For example, the temporal machine learning model may be trained with a training set of (prior) data (from spatial machine learning model 325), where the neural network attempts to produce the provided or known data (e.g., current and future data values) and uses an error from the output (e.g., difference between inputs and outputs) (and the imputation error from spatial machine learning model 325) to adjust weight (and bias) values. The output layer of the neural network indicates a corresponding data set (with current and future values) for input data.

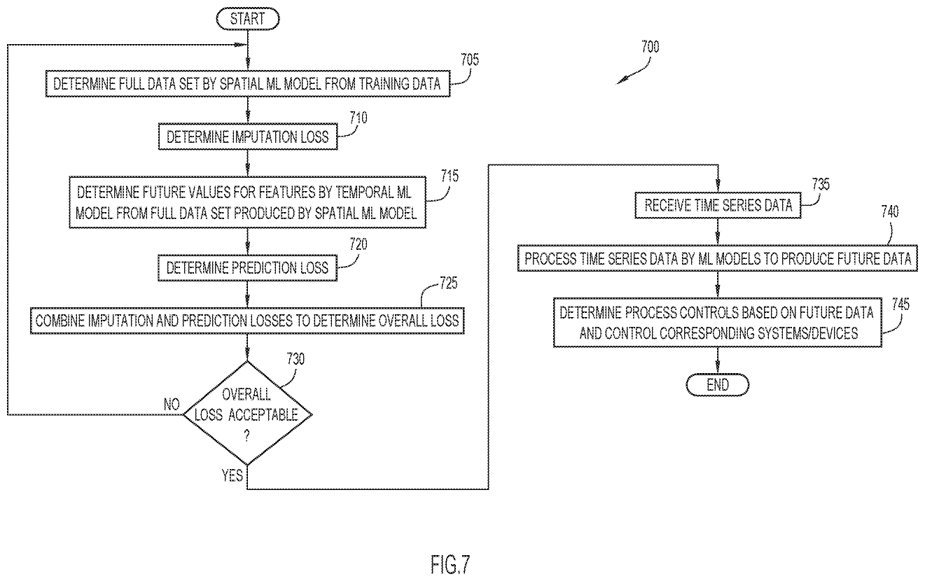

A method 700 of processing time series data (e.g., via time series ML code 200) according to an embodiment of the present invention is illustrated in FIG. 7. Initially, machine learning (ML) models 325, 345 are simultaneously trained by time series machine learning (ML) code 200 on different tasks. For example, spatial machine learning model 325 is trained for Z=f(Z*), and temporal machine learning model 345 is trained for forecasting for Z+=g(Z) (e.g., for each feature). The spatial machine learning model is associated with an imputation loss function. Similarly, the temporal machine learning model is associated with a prediction loss function. The imputation loss function (of the spatial machine learning model 325) and the prediction loss function (of the temporal machine learning model 345) are combined to produce an overall loss function that is used for training machine learning models 325, 345.

Spatial machine learning (ML) model 325 receives a partial data set (Data Z*) from training data, and produces a full data set (Data Z) at operation 705. An imputation loss based on a comparison of the produced full data set (Data Z) to a known full data set is determined at operation 710. By way of example, the imputation loss function for spatial machine learning model 325 (or function f) is a Frobenius norm in some embodiments and expressed as:

$$Imputation Loss ( Z ) = {‖ ( Z - f ( Z * ) ) ⊙ {M}_{Z} ‖}^{2} ( Frobenius norm ) ,$$

where ⊙ denotes the Hadamard product (element-wise multiplication), and M_{Z} is a mask matrix for data set Z (in the form of a matrix as described above) for indicating missing data. The imputation loss function basically indicates a distance between the produced and known data, where the mask matrix enables the appropriate data (corresponding to the missing data) to be compared between the known and produced data sets.

Temporal machine learning (ML) model 345 processes the full data set (Data Z) from spatial machine learning (ML) model 325 for the features, and produces current and predicted future values for the features (Data Z+) at operation 715. A prediction loss based on a comparison of the produced data set (Z+) to a known data set is determined at operation 720. By way of example, the prediction loss function for temporal machine learning model 345 (or function g) is a Frobenius norm in some embodiments and expressed as:

$$Prediction Loss ( Z , Z + ) = {‖ ( Z + - g ( f ( Z * ) ) ) ⊙ {M}_{Z +} ‖}^{2} ( Frobenius norm ) ,$$

where ⊙ denotes the Hadamard product (element-wise multiplication), and M_{Z+} is a mask matrix for data set Z+ for indicating missing data. The prediction loss function basically indicates a distance between the produced and known data, where the mask matrix enables the appropriate data (corresponding to the missing data) to be compared between the known and produced data sets.

The imputation loss and prediction loss are combined at operation 725 to produce an overall loss. By way of example, the overall loss function is expressed in some embodiments as:

$$Overall Loss ( Z ) = Imputation Loss ( Z ) + Prediction Loss ( Z , Z + ) + reg ( {w}_{f} , {w}_{g} ) ,$$

where reg is a regularization (or normalization or smoothing) function to control adjustment of the weights (w_{f} and w_{g}) of the neural networks of machine learning models 325, 345. The regularization function basically adds a penalty to the loss function to control weight adjustments, and may be implemented using any conventional or other techniques (e.g., L2 regularization, etc.). The overall loss function is used for adjusting weights of machine learning models 325, 345 (e.g., via backpropagation, etc.). Thus, the spatial and temporal machine learning models are trained simultaneously (with the set of functions 440 being trained simultaneously).

Spatial and temporal machine learning models 325, 345 are simultaneously trained until the overall loss is acceptable (e.g. minimized, converges, satisfies a threshold, etc.) as determined at operation 730.

Once spatial and temporal machine learning models 325, 345 are trained, time series data (e.g., sensor measurements of systems/devices or other data) is received at operation 735. The time series data may include missing values due to various conditions (e.g., database corruption, sensor failure, a multi-resolution sensor network, etc.). Spatial and temporal machine learning models 325, 345 process the data to predict future values at operation 740. In particular, spatial machine learning model 325 processes the time series data (with missing values) and produces a learned full data set. The learned full data set associated with features is provided to temporal machine learning model 345 to predict or determine future values for the features.

The learned full data set (or current values) and the predicted future values are processed to determine controls for systems/devices at operation 745. The controls are provided to the systems/devices to adjust operation based on the predicted future values to attain desired operating conditions (e.g., power consumption, temperature, throughput, etc.).

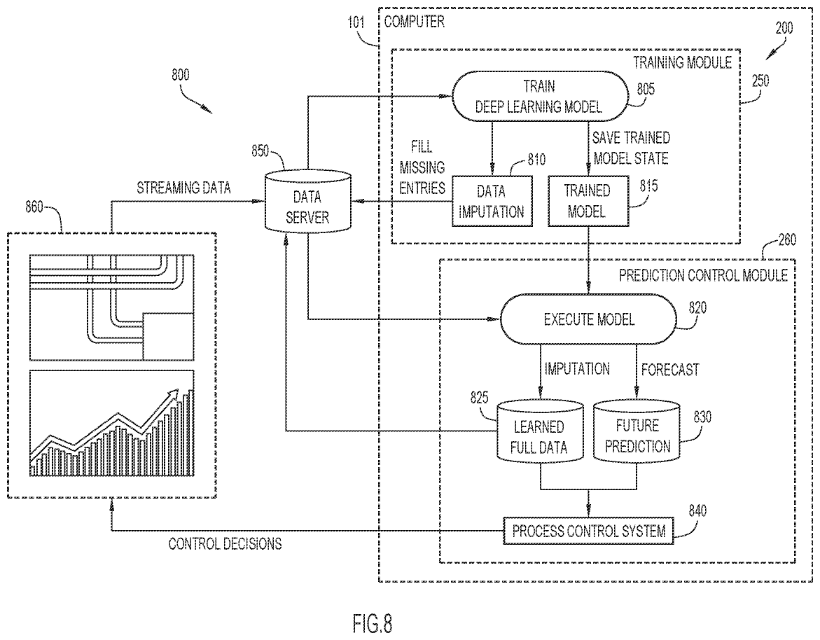

An example machine control system 800 according to an embodiment of the present invention is illustrated in FIG. 8. Initially, machine control system 800 includes computer 101, a data server 850, and machines (or systems or devices) 860 (e.g., manufacturing, sensing, etc.). Machines 860 include sensors or other devices to obtain measurements or other data for features that are provided to and stored in data server 850. The data is streamed and includes time series data corresponding to features at a corresponding time interval or time step. Time series machine learning (ML) code 200 includes a training module 250 and a prediction and control module 260 to process data stored in data server 850. Training module 250 performs operations for machine learning model training, and prediction and control module 260 performs operations for generating predictions and controls for machines 860.

Training module 250 receives data from data server 850 and trains spatial and temporal machine learning models 325, 345 at operation 805 in substantially the same manner described above. The training module 250 provides imputed data derived from spatial machine learning model 325 to data server 850 for storage at operation 810 to improve training, forecasting, and/or prediction (e.g., the data may be used to update or augment a training set). The training module 250 further stores or saves the trained spatial and temporal machine learning models at operation 815 (e.g., model state, weight values, etc.).

Prediction and control module 260 retrieves time series data from data server 850 and further retrieves and executes the trained spatial and temporal machine learning models at operation 820. The time series data may include missing values due to various conditions (e.g., database corruption, sensor failure, a multi-resolution sensor network, etc.). Spatial machine learning model 325 processes the time series data (with missing values) and produces a learned full data set 825. The learned full data set associated with features is provided to temporal machine learning model 345 to predict or determine future values 830. The learned data set is provided to data server 850 to improve training, forecasting, and/or prediction (e.g., the data may be used to update or augment a training set).

Prediction and control module 260 processes the learned full data set (or current values) and the predicted future values to generate controls, e.g., commands for control actions, for machines 860 at operation 840. The controls are provided to machines 860 to adjust operation of the machines based on the predicted future values to attain desired operating conditions (e.g., power consumption, temperature, throughput, etc.). The future values basically enable control decisions to be rendered. For example, when the future values indicate increased power consumption, increased temperature, and/or reduced throughput, the controls adjust operation of machines 860 (e.g., adjust speed, power down, adjust cooling/heating mechanisms, etc.) to enable the machines to operate within desired conditions (e.g., or within various ranges or thresholds).

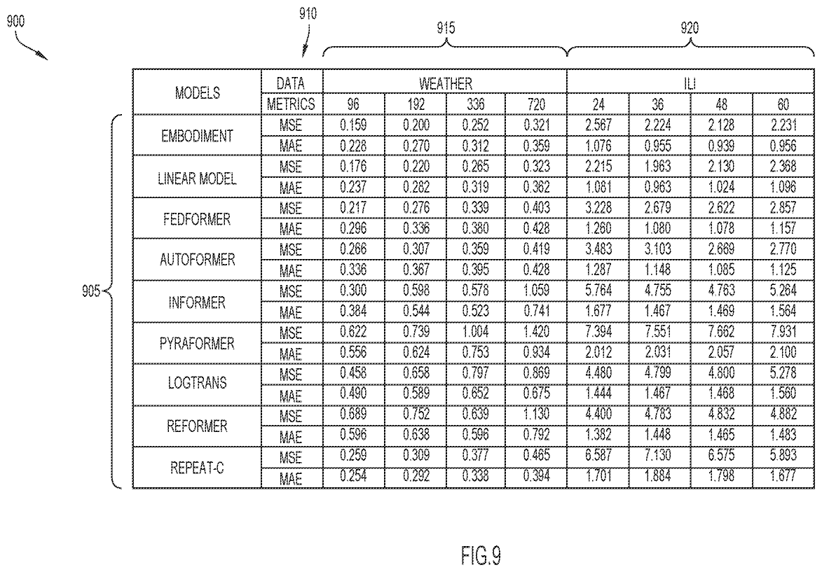

Operation of an embodiment of the present invention relative to conventional approaches is illustrated in FIG. 9. Initially, operation of an embodiment of the present invention (labeled as “EMBODIMENT” in FIG. 9) was compared with various conventional approaches including Linear model, FEDformer, Autoformer, Informer, Pyraformer, LogTrans, Reformer, and Repeat-C. Metrics for the operations are presented in the form of a table 900 including rows 905 and columns 910, 915, 920. Rows 905 each represent a corresponding approach (with EMBODIMENT referring to an embodiment of the present invention) with respect to weather related data (e.g., 21 meteorological indicators) and weekly recorded influenza-like illness (ILI) patient data. Column 910 indicates a type of metric (e.g., mean square error (MSE), mean average error (MAE), etc.), while columns 915 correspond to varying prediction lengths (or time intervals or time steps of data) for weather related data (e.g., prediction lengths of 96, 192, 336, and 720 for an input length of 96). Columns 920 correspond to varying prediction lengths (or time intervals or time steps of data) for weekly recorded influenza-like illness patient data (e.g., lengths of 24, 36, 48, and 60 for an input length of 36). The metrics for an embodiment of the present invention indicate better operation in an overwhelming majority of scenarios.

Present invention embodiments may provide various technical and other advantages. In an embodiment, training of plural machine learning models may be performed simultaneously, thereby reducing training iterations to provide quicker training and reducing utilization of computing resources. The machine learning models are interrelated during training (e.g., output of a model is connected to the input of another model) and use a combined loss function to improve accuracy. In this case, the imputation task affects learning or accuracy of prediction and vice versa. Further, several functions of a machine learning model for different features may be trained simultaneously, thereby reducing training iterations to provide quicker training and reducing utilization of computing resources. Moreover, the machine learning models may be continuously updated (or trained) based on resulting imputed data and predicted data sets. For example, imputed data and predicted data sets may be used to update or train the machine learning models with new or different training data to improve accuracy. Thus, the machine learning models may continuously evolve (or be trained) to learn the functions for imputing and predicting data. In addition, the system may control any types of systems, machines, and/or devices based on processing time series data to predict future values of features of those systems, machines, and/or devices. The predicted values are used to generate controls that may be provided to control operation of the systems, machines, and/or devices.

It will be appreciated that the embodiments described above and illustrated in the drawings represent only a few of the many ways of implementing embodiments for process control based on simultaneous machine learning of spatial and temporal relations of time series data.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., time series machine learning code 200, training module 250, prediction and control module 260, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user.

The present invention embodiments are not limited to the specific tasks or algorithms described above, but may be utilized for processing of time series data related to any source (e.g., operational or other systems, machines, devices, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, via at least one processor, one or more sets of time series data values recorded from operation of a system for respective features of the system;
imputing, via a first machine learning model, missing data values from the one or more sets of time series data values;
predicting, via a second machine learning model, data values for the features for a future time based on receiving the set of time series data values and the imputed data values from the first machine learning model as input, wherein the first and the second machine learning models implement different functions for corresponding different features of the system; and
generating, via the at least one processor, one or more commands for control operations for the system based on the predicted data values.

2. The computer-implemented method of claim 1, wherein the first machine learning model comprises a fully connected neural network.

3. The computer-implemented method of claim 1, wherein the predicted future values are for a next step ahead and for multiple steps ahead.

4. The computer-implemented method of claim 1, wherein the second machine learning model comprises a convolutional neural network.

5. The computer-implemented method of claim 4, wherein the convolutional neural network comprises linear layers and performs a depth-wise separable convolution on the different features.

6. The computer-implemented method of claim 4, further comprising training the convolutional neural network to simultaneously learn the different functions for the corresponding different features.

7. The computer-implemented method of claim 1, further comprising training the first and the second machine learning models simultaneously based on a combined loss.

8. The computer-implemented method of claim 1, further comprising training the first and the second machine learning models via:
determining an imputation loss for the first machine learning model imputing missing data values for training data;
determining a prediction loss for the second machine learning model predicting future data values related to the training data; and
combining the imputation loss and the prediction loss to determine an overall loss, wherein the first and the second machine learning models are trained simultaneously based on the overall loss.

9. A computer system comprising:
one or more memories; and
at least one processor coupled to the one or more memories, and configured to:
receive one or more sets of time series data values recorded from operation of a system for respective features of the system;
impute, via a first machine learning model, missing data values from the one or more sets of time series data values;
predict, via a second machine learning model, data values for the features for a future time based on receiving the set of time series data values and the imputed data values from the first machine learning model as input, wherein the first and the second machine learning models implement different functions for corresponding different features of the system; and
generate one or more commands for control operations for the system based on the predicted data values.

10. The computer system of claim 9, wherein the first machine learning model comprises a fully connected neural network.

11. The computer system of claim 9, wherein the predicted future values are for a next step ahead and for multiple steps ahead.

12. The computer system of claim 9, wherein the second machine learning model comprises a convolutional neural network.

13. The computer system of claim 12, wherein the convolutional neural network comprises linear layers and performs a depth-wise separable convolution on the different features.

14. The computer system of claim 12, wherein the at least one processor is further configured to train the convolutional neural network to simultaneously learn the different functions for the corresponding different features.

15. The computer system of claim 9, wherein the at least one processor is further configured to train the first and the second machine learning models simultaneously based on a combined loss.

16. The computer system of claim 9, wherein the at least one processor is further configured to train the first and the second machine learning models via:
determining an imputation loss for the first machine learning model imputing missing data values for training data;
determining a prediction loss for the second machine learning model predicting future data values related to the training data; and
combining the imputation loss and the prediction loss to determine an overall loss, wherein the first and the second machine learning models are trained simultaneously based on the overall loss.

17. A computer-implemented method comprising:
training a system comprising first and second machine learning models via:
determining an imputation loss for the first machine learning model imputing missing time series data values for training data;
determining a prediction loss for the second machine learning model predicting future data values related to the training data, wherein the system comprises a model structure with output of the first machine learning model being input into the second machine learning model; and
combining the imputation loss and the prediction loss to determine an overall loss so that the first and the second machine learning models are trained simultaneously.

18. The computer-implemented method of claim 17, wherein the first machine learning model comprises a fully connected neural network.

19. The computer-implemented method of claim 17, wherein the second machine learning model comprises a convolutional neural network.

20. The computer-implemented method of claim 19, wherein the convolutional neural network comprises linear layers and performs a depth-wise separable convolution on the different features.
